(19) United States
(12) Patent Application Publication
(10) Pub. No.: US 2016/0078442 A1
(43) Pub. Date: Mar. 17, 2016

(54) USER ID WITH INTEGRATED DEVICE SETUP PARAMETERS

(71) Applicant: Sony Corporation, Tokyo (JP)

(72) Inventors: Peter Shintani, San Diego, CA (US); Robert Noel Blanchard, Escondido, CA (US)

(21) Appl. No.: 14/483,711

(22) Filed: Sep. 11, 2014

(51) Int. Cl. G06Q 20/40

(52) U.S. Cl. CPC G06Q 20/4014; G06Q 2220/10

(57) ABSTRACT

To eliminate the need for a user to laboriously enter device setup parameters into each of plural devices, a user ID is provided with a secure part, having the user's login credentials, and an unsecure device parameter part which defines device parameters desired by the user to be set in computing devices.

### FIELD OF THE INVENTION

The application relates generally to user IDs with integrated device setup parameters.

### BACKGROUND OF THE INVENTION

A computer ecosystem, or digital, ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

### SUMMARY OF THE INVENTION

An example ecosystem that is pertinent here is a network of a particular user's devices. As understood herein, a user must manually enter user preferences into each of his devices during set up, or when the principal user of the device changes.

Accordingly, a device includes at least one non-transitory computer readable storage medium with instructions executable by a processor to configure the processor for receiving a user identification data block, and retrieving from a non-secure, unencrypted partition of the date block device setting information. The instructions when executed by the processor also configure the processor for automatically establishing at least one display device setting according to the setting information. Further, the instructions when executed by the processor also configure the processor for retrieving from a secure, encrypted partition of the data block personal information of a person, and using the personal information to effect a transaction.

In some embodiments information in the non-secure, unencrypted partition of the data block contains no information uniquely identifying a person. Information in the secure, encrypted partition of the data block may contain no device setting information. Information in the secure, encrypted partition of the data block can include a person's legal name and a person's financial account information useful for effecting a monetary transaction.

In examples, information in the non-secure, unencrypted partition of the data block can include at least one video display setting and/or at least one audio setting. In specific examples information in the non-secure, unencrypted partition of the data block includes display settings, closed captioning settings, language settings, video description preference settings, font size setting, and contrast setting, singly, together, or in any combination thereof. If desired, the instructions when executed by the processor may configure the processor for using the information in the secure, encrypted partition of the data block to establish a video-on-demand service.

In another aspect, a device includes at least one processor and at least one computer readable storage medium with instructions executable by the processor to configure the processor to receive personal information of a person, receive display device setting preferences of the person, and combine the personal information and the display device setting preferences of the person into a single user identification (ID). The personal information is encrypted, while the display device setting preferences are not encrypted.

In another aspect, a method includes, pursuant to a transaction in which a display device is vended to a person, collecting personal information identifying the person. The method also includes, pursuant to the transaction, collecting display device setting preferences of the person, and combining the personal information and the display device setting preferences in a user ID. The personal information is in an encrypted part of the user ID, while the display device setting preferences are in an unencrypted part of the user ID.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a schematic diagram of an example partitioned user identification (ID)

data block; and

FIGS. 3 and 4 are flow charts of example logic according to present principles.

### DETAILED DESCRIPTION

This disclosure relates generally to computer ecosystems including aspects of consumer electronics (CE) device based user information in computer ecosystems. A system herein, may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony Playstation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interlaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can he implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

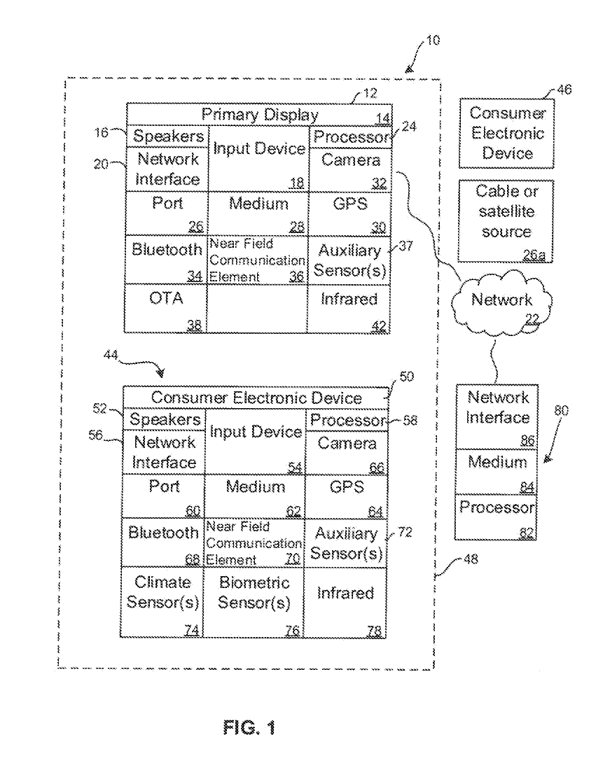

Now specifically referring to FIG. 1, an example ecosystem 10 is shown, which may include one or more of the example devices mentioned above and described further below in accordance with present principles. The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). However, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook-computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that, may be touch-enabled for receiving user input signals via touches on the display. The AVDD 12 may include one or more speakers 16 for outputting audio in accordance with present principles, and at least one additional input device 18 such as e.g. an-audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc, under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interlace such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below.

The AVDD 12 may further include one or more tangible computer readable storage medium 28 such as disk-based or solid state storage, in some cases embodied in the chassis of the AVDD as standalone devices or as a personal video recording device (PVR) or video disk player either internal or external to the chassis of the AVDD for playing back AV programs. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include an over-the-air TV broadcast port 38 for receiving OTH TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shows, to illustrate present principles ail three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer, and accordingly may have cue or more of the components described below. The second CE device 46 without limitation may be established by a video disk player such as a Blu-ray player, a game console, and the like. The first CE device 44 may be a remote control (RC) for, e.g., issuing AV play and pause commands to the AVDD 12, or it may be a more sophisticated device such as a tablet, computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interlaces. It is to be understood that the processor 38 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or rooter, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 42 such as an IR data association (IRDA) device. A battery (not shown) may be provided for powering the first CE device 44. The CE device 44 may communicate with the AVDD 12 through any of the above-described communication modes and related components.

The second CE device 46 may include some or all of the components shown for the CE device 44.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

In the logic below, personal and device setting information may be assembled into a user ID by a point of sale computer that may be implemented by, e.g., the CE device 46 shown in FIG. 1. The user ID may then be input into, e.g., the AVDD 12 and/or CE device 44 to automatically configure settings on those devices and to use sensitive personal data in the user ID for, e.g., financial transactions according to logic below. The input of the user ID may be effected by providing the network addresses of the AVDD 12 and CE device 44 to the point of sale computer and then automatically sending the user ID over a network from the POS computer to the AVDD 12 or CE device 44. Or, the user ID may be transferred to a portable storage such as a thumb drive, given to the consumer, who can engage the thumb drive with the AVDD 12 or CE device 44 to download the user ID into those devices. Other means For providing the user ID to the AVDD 12 and CE device 44 may be used. For example, the user ID may be maintained by the POS computer and then for subsequent purchases of CE devices, the POS computer may automatically download the user ID into the purchased computers once the purchaser is correlated with the purchased computers at or by the POS computer.

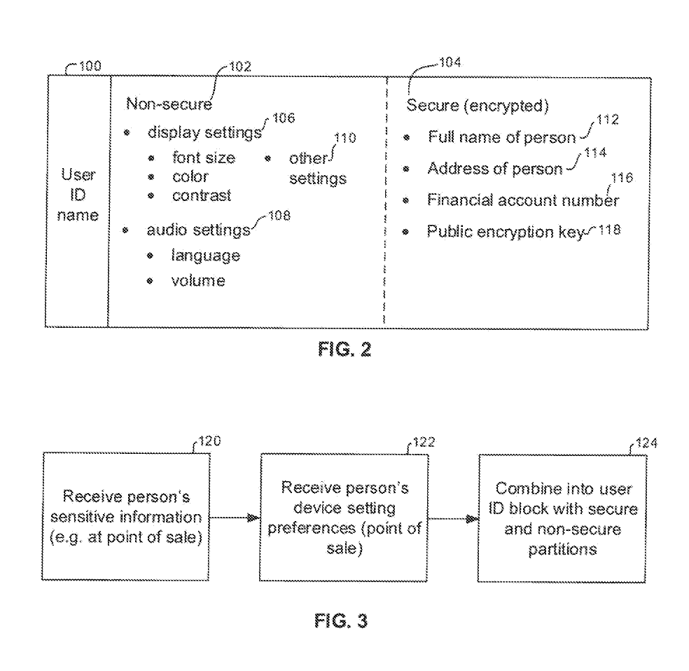

Now referring to FIG. 2, a user ID is shown which may be accorded a name 100 (that need not be a full personal name, e.g., that may simply be “John's ID” or other phrase that does not uniquely describe a person) in which data is partitioned into a non-secure partition 102 and a secure partition 104 that may be rendered secure by, e.g., encrypting the data in the secure partition 104 with a public key/private key pair or other encryption technique.

The non-secure partition 102 of the example partitioned user identification (ID) data block may contain no identifying information of the user and may include a display settings element 106 and an audio settings element 108. The display and audio settings elements 106, 108 correspond to the user's preferences for the video and audio components of the device, respectively. The display settings element 106 may include settings such as font size, color, contrast, etc., while the audio settings element 108 may include settings such as language, volume, closed-captions, etc. An “other settings” element 110 can be presented to the user in the non-secure partition 102 and may include settings that do not fall under display or audio elements 106, 108,

Both the non-secure partition 102 and the secure partition 104 of the unique ID can be configured at the point of sale or by a customer service representative. The unique ID can be used to automatically configure any consumer device the user chooses without user interaction with the consumer device's user interface or settings menu.

Disability-specific configurations may be included in both the display settings element 106 and the audio settings element 108 within the non-secure partition 102. Different disabilities are treated independently and individually, and thus some configurations are separate and some may be intertwined. For example, one user may be visually impaired and another user may be blind. All the configurations that are enabled for the visually impaired user may not affect those of the blind user. So they can be added to the blind person's configurations if the blind person is the top in the hierarchy, i.e. the master user in the device's profile log. However, a visually impaired person may not wish to have some configurations, such as a screen reader, enabled for the blind person. In the ease that the visually impaired user is the top person in the hierarchy, there can be an option provided to the user to instruct or not to instruct the device to permit the screen reader feature. The key to this hierarchy is identifying the user and automatically adjusting the settings to accommodate the user preferences. In this case a blind user would identify and the device would automatically configure the device to that user's preferences; likewise the same functionality would apply to a hard of hearing user. The hierarchy would be set to accommodate the case when two users are identified. In this case priorities could be set in ranking order. For example, the blind user's settings are given highest priority and the hard of hearing user's a lower priority. Similarly, this example can be reversed or additionally the priority settings could be set to a group of accessibility features to accommodate both users. (Similar separation or intertwining of configurations may apply to other disabilities, e.g. hearing impairment and deafness.)

In the instance of a visually impaired user, display settings may be configured to language preference of English and an activated navigation setting that identifies and announces programs with an English language video description. The same visually impaired user may also have the audio settings configured to maintain an audio volume level configured to medium, tone configured to emphasize treble sounds, and mute function disabled.

In an example case of a Spanish-speaking and hearing impaired user, audio configurations may be included under the audio-setting element 108. These may include closed captioning configured to “on,” closed captioned language preference configured to Spanish, font size configured to large, closed caption characters color configured to solid yellow, closed caption window background color configured to solid blue, audio configured to “on” and at a normal volume configuration, a mute function configured to have no effect upon display of closed captions, etc.

The secure, encrypted partition 104 can contain additional information that may include user-identifying information, e.g. financial information. Financial information that is needed to establish an account with a paid or free service could be provided in the secure partition 104. For example, a video-on-demand (VOD) service may require name, location, credit card, expense limits information, etc.

In the example embodiment illustrated in FIG. 2, text elements are included in the secure partition 104 and include a full name of the user 112, an address of the user 114, a financial account number 116, and a public encryption key 118. This information identifies the user, whether personally or financially, and would be protected by password or other means in the secure partition 104.

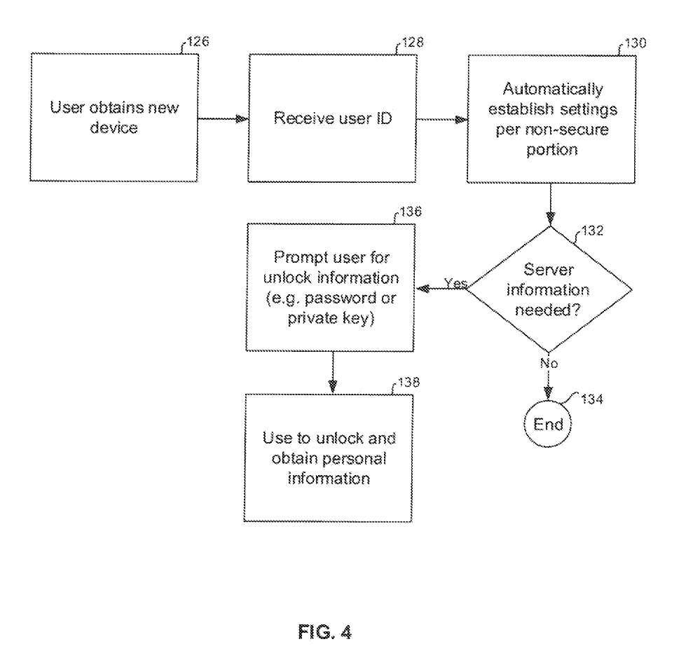

Moving in reference to the example logic embodied in the flow chart of FIG. 3, a processor, such as the processor 24 of the AVDD 12 in FIG. 1, may receive a user's sensitive identifying information, e.g. at the point of sale, at block 120. Additionally, the processor may receive a user's device setting configurations, e.g. at point of sale, at block 122. The processor may combine both sets of information into user ID block partitions: the sensitive identifying information into the secure partition 104 and the device setting configurations into the non-secure partition 102.

Now referring to the example logic embodied by the flow chart illustrated in FIG. 4, a user can obtain a new device, e.g. the AVDD 12 of FIG. 1, at block 126. The processor of that device may receive a user ID at block 128. The processor can automatically establish device setting configurations at block 130 as per the non-secure partition 102 of the user ID.

The processor may subsequently determine whether secure, sensitive identifying information is needed at decision diamond 132. Logic moves to and terminates at block 134, “End,” if the processor determines that no secure information is needed. Alternatively, if the processor determines that secure information is needed, the logic may move forward to block 136, at which point the processor prompts the user for unlock information, e.g. password or private key. Once the processor obtains the correct unlock information, it may unlock and obtain the secure, sensitive identifying information.

The above methods may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD Rom or Flash drive. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement the subject matter claimed herein.

What is claimed is:

1. A device comprising:
at least one non-transitory computer readable storage medium with instructions executable by a processor to configure the processor for:
receiving a user identification data block;
retrieving from a non-secure, unencrypted partition of the data block device setting information;
automatically establishing at least one display device setting according to the setting information;
retrieving from a secure, encrypted partition of the data block personal information of a person; and
using the personal information to effect a transaction.

2. The device of claim 1, wherein information in the non-secure, unencrypted partition of the data block contains no information uniquely identifying a person.

3. The device of claim 1, wherein information in the secure, encrypted partition of the data block contains no device setting information.

4. The device of claim 1, wherein information in the secure, encrypted partition of the data block includes a person's legal name.

5. The device of claim 1, wherein information in the secure, encrypted partition of the data block includes a person's financial account information useful for effecting a monetary transaction.

6. The device of claim 1, wherein information in the non-secure, unencrypted partition of the data block includes at least one video display setting.

7. The device of claim 1, wherein information in the non-secure, unencrypted partition of the data block includes at least one audio setting.

8. The device of claim 1, wherein information in the non-secure, unencrypted partition of the data block includes display settings, closed captioning settings, language settings, video description preference settings, font size setting, and contrast setting.

9. The device of claim 1, wherein information in the non-secure, unencrypted partition of the data block includes at least one setting useful for prioritizing settings associated with respective plural users in a hierarchy.

10. The device of claim 1, wherein the instructions when executed by the processor configure the processor for:
using the information in the secure, encrypted partition of the data block to establish a video-on-demand service.

11. A device comprising:
at least one processor; and
at least one computer readable storage medium with instructions executable by the processor to configure the processor to:
receive personal information of a person:
receive display device setting preferences of the person; and
combine the personal information and the display device setting preferences of the person into a single user identification (ID), the personal information being encrypted, the display device setting preferences not being encrypted.

12. The device of claim 11, wherein the instructions when executed by the processor configure the processor to:
group the display device setting preferences in a non-secure, unencrypted partition of the user ID; and
group the personal information in a secure, encrypted partition of the user ID.

13. The device of claim 12, wherein information in the non-secure, unencrypted partition of the data block contains no information uniquely identifying a person.

14. The device of claim 12, wherein information in the secure, encrypted partition of the data block contains no device setting information.

15. The device of claim 12, wherein information in the secure, encrypted partition of the data block includes a person's legal name.

16. The device of claim 12, wherein information in the non-secure, unencrypted partition of the data block includes at least one setting useful for prioritizing settings associated with respective plural users in a hierarchy.

17. The device of claim 12, wherein information in the non-secure, unencrypted partition of the data block includes at least one video display setting.

18. The device of claim 12, wherein information in the non-secure, unencrypted partition of the data block includes at least one audio setting.

19. The device of claim 12, wherein, information in the non-secure, unencrypted partition of the data block includes at least one setting from the group of setting including: display settings, closed captioning settings, language settings, video description preference settings, font size setting, and contrast setting.

20. A method comprising:
pursuant to a transaction in which a display device is vended to a person, collecting personal information identifying the person;
pursuant to the transaction, collecting display device setting preferences of the person; and
combining the personal information and the display device setting preferences in a user ID, the personal information being in an encrypted part of the user ID, the display device setting preferences being in an unencrypted part of the user ID.
